(19) United States
(12) Patent Application Publication
(10) Pub. No.: US 2010/0004970 A1
(43) Pub. Date: Jan. 7, 2010

(54) METHOD AND STRUCTURE FOR IMPLEMENTING B2B TRADING PARTNER BOARDING

(75) Inventors: Didier Boullery, Sartrouville (FR); Jennifer D. Cihla, Armonk, NY (US); Peter S. Cook, Larkspur, CA (US); Nicolas Derivery, Paris (FR); Teresa M. Diute, Binghampton, NY (US); Thomas E. Edwards, New Fairfield, CT (US); Caren D. Ekenstierna, Raleigh, NC (US); Raymond Fallon, Poughkeepsie, NY (US); Niels Gjerloev, Stockholm (SE); George Havens, Woodstock, NY (US); Robert E. Lambert, Brookfield, CT (US); Nicole Bari Narcisco, Raleigh, NC (US); Michael Otten, Scarsdale, NY (US); Joerg Rakoczy, Stuttgart (DE); Timothy Sheffler, Monroe, NY (US); Stephen Snook, Lagrangeville, NY (US); Patricia M. Spugani, New Canaan, CT (US); R. Peter Williams, Danville, CA (US); Lisa M. Youngclaus, Sparta, NJ (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 12/545,651

(22) Filed: Aug. 21, 2009

Related U.S. Application Data
(63) Continuation of application No. 10/975,945, filed on Oct. 29, 2004.

(51) Int. Cl. G06Q 10/00; G06F 17/30

(52) U.S. Cl. 705/8; 707/104.1; 705/7; 707/E17.044

(57) ABSTRACT

A computerized method (and structure) of implementing a business-to-business (B2B) boarding process includes providing a set of questions related to the B2B boarding process to a new business to be boarded into an existing B2B system.

This application is a Continuation application of U.S. patent application Ser. No. 10/975,945, filed on Oct. 29, 2004, now U.S. Pat. No. ______.

### DESCRIPTION

### Background of the Invention

1. Field of the Invention

The present invention generally relates to a computer interface between business entities for performing business-related tasks, such as placing and servicing orders. More specifically, in a business-to-business (B2B) environment, a computerized method is used to configure and support a standardized, modular, and highly repeatable implementation process to provide a boarding process that allows an existing B2B gateway to be quickly modified through a computerized boarding process to accommodate the specific formats, protocols, and other logistical requirements of a new trading partner.

2. Description of the Related Art

In the context of e-commerce and the increasingly important role of computers in conducting even routine business transactions, the term “B2B” (business-to-business) implies an interactive business relationship between two or more businesses in which business transactions are supported and the individual processes of each business entity is accommodated in the B2B environment.

In the context of the present invention, B2B is intended to refer to the seamless electronic integration among multiple business entities, referred hereinto as “trading partners”. Increasingly, in current technology, this electronic integration is based on XML (Extensible Markup Language), although such constraint is not necessary for implementation of the present invention.

Unfortunately, conventional methods for the B2B boarding process can result in months of effort and cost hundreds of thousands of dollars to implement. Historically, implementations of a B2B transaction with a new trading partner have been characterized by substantial variations in cost and time. These variations can be driven by technology constraints (both back end and front end) by the fact that a larger company will typically contain numerous business units each with their own methods of doing business and their own preferred B2B protocols which must be reconciled with each other, and even by linguistic differences between teams working on international implementations.

Thus, a need exists to provide a B2B boarding implementation method that reduces time and cost.

### SUMMARY OF THE INVENTION

In view of the foregoing, and other, exemplary problems, drawbacks, and disadvantages of the conventional system, an exemplary benefit of the present invention is to provide a computerized process management tool that allows the boarding process to be configured rapidly and efficiently in response to a series of questions answered by the user.

It is another exemplary benefit of the present invention to provide a standardized, modular, and highly repeatable process to rapidly and effectively implement a boarding process with new trading partners.

It is another exemplary benefit of the present invention to provide a boarding process that can automatically configure components of the boarding process.

To achieve the above exemplary benefits and others, in a first exemplary aspect of the present invention, described herein is a method (and structure) of computerizing elements of the implementation of a business-to-business (B2B) boarding process, including providing a set of questions related to the B2B boarding process to a new business to be boarded into an existing B2B system.

In a second exemplary aspect of the present invention, described herein is an apparatus including a user interface (UI) for at least one of: providing a set of questions related to a business-to-business (B2B) boarding process to a new business to be boarded into an existing B2B system, means for allowing a user to respond to the set of questions, means for entering the set of questions into a questionnaire, means for entering commands to control an analysis of the responses with a database containing B2B boarding process information, and means for displaying a result of the analysis.

In a third exemplary aspect of the present invention, described herein is a server in a computer network that includes a memory containing data on a business-to-business (B2B) boarding process for comparison with responses to a questionnaire for a new B2B boarding process.

In a fourth exemplary aspect of the present invention, described herein is a system including a database containing business-to-business (B2B) boarding process information, a user interface (UI) for at least one of: providing a set of questions related to the B2B boarding process to a new business to be boarded into an existing B2B system, means for allowing a user to respond to the set of questions, means for entering the set of questions into a questionnaire, means for entering commands to control an analysis of the responses with the database containing B2B boarding process information, means for displaying a result of the analysis, and a memory interface to the database.

In a fifth exemplary aspect of the present invention, described herein is a signal-bearing medium tangibly embodying a program of machine-readable instructions executable by a digital processing apparatus to perform a computerized method of at least assisting in an implementation of a business-to-business (B2B) boarding process, the instructions on the signal-bearing medium including at least one of: instructions to present a set of questions related to the B2B boarding process to a new business to be boarded into an existing B2B system; instructions for a user interface (UI) for at least one of providing a set of questions related to the B2B boarding process to a new business to be boarded into an existing B2B system, means for allowing a user to respond to the set of questions, means for entering the set of questions into a questionnaire, means for entering commands to control an analysis of the responses with the database containing B2B boarding process information, and means for displaying a result of the analysis; instructions to interface to the database; and at least one expert system to at least one of: compare the responses with the B2B boarding process information in the database, prepare information for a new boarding process based on the responses, and prepare components for the new boarding process.

In a sixth exemplary aspect of the present invention, described herein is a method of implementing a business-to-business (B2B) boarding process, including means for presenting a set of questions related to the B2B boarding process to a new business to be boarded into an existing B2B system and means for comparing responses to the questions with information in a database containing B2B boarding process information and developing information related to a boarding process based on the responses.

In a seventh exemplary aspect of the present invention, described herein is a method of implementing a business-to-business (B2B) system between two business entities, including at least one of receiving a questionnaire having questions related to the implementation of a B2B system, providing the questionnaire to a representative of a potential trading partner, responding to the questions on the questionnaire as a representative of the potential trading partner, receiving responses of the questions on the questionnaire, consulting a database containing data on possible responses to the questions, determining information related to a new B2B system implementation, based on the consulting, and implementing at least one B2B system component, based on the determining information.

In an eighth exemplary aspect of the present invention, described herein is a service to at least assist in implementing a business-to-business (B2B) boarding process, including at least one of developing a questionnaire having questions related to the implementation of a B2B system, providing the questionnaire to a representative of a business entity, receiving responses of the questions on the questionnaire, consulting a database containing data on possible responses to the questions, determining information related to a new B2B system implementation, based on the consulting, implementing at least one B2B system component, based on the determining information, developing the database, and maintaining the database.

Thus, the present invention provides a technique in which a single boarding process is rendered significantly more versatile than otherwise possible. For example, it provides an optimum process configured automatically or semi-automatically for any type of boarding. It provides a savings in time taken and cost to achieve any given boarding, both from improved process and fewer errors. Moreover, the present invention provides an increase in scalability of B2B (e.g., its ability to be rolled out to multiple trading partners), so enhancing “network effects” for the companies operating the b2b transaction sin question, and so offering further economies of scale.

### BRIEF DESCRIPTION OF THE DRAWINGS

The foregoing and other exemplary features, aspects and advantages will be better understood from the following detailed description of an exemplary embodiment of the invention with reference to the drawings, in which:

FIG. 1 shows an exemplary conventional B2B architecture 100;

FIG. 2 shows a first exemplary conventional variation in which B2B components are functionally combined;

FIG. 3 shows another conventional variation 300 in which B2B components are out-sourced to an external service provider;

FIG. 4 shows the concept 400 of a conventional end-to-end business process 401;

FIG. 5 shows a summary 500 of the flow of the phases of a boarding process implemented in accordance with the present invention;

FIGS. 6A-6C show in chart format an exemplary set of questions 600A-600C for which responses allow a new business to be accommodated by an existing B2B system;

FIG. 7 shows a flowchart of an exemplary computerized tool 700 used in the present invention;

FIG. 8 illustrates an exemplary computerized tool 800 that implements the present invention;

FIG. 9 illustrates an exemplary hardware/information handling system 900 for incorporating the present invention therein; and

FIG. 10 illustrates a signal bearing medium 1000 (e.g., storage medium) for storing steps of a program of a method according to the present invention.

### DETAILED DESCRIPTION OF EXEMPLARY EMBODIMENTS OF THE INVENTION

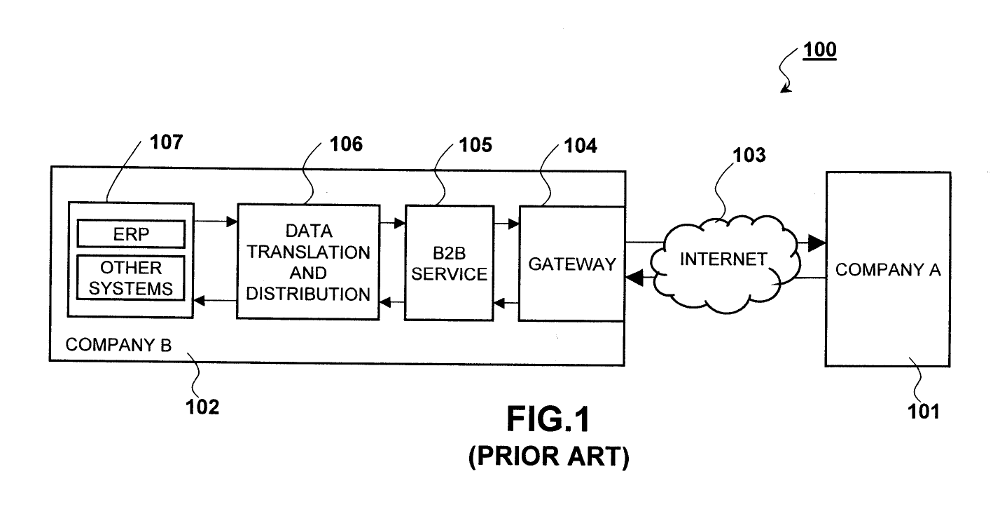

Referring now to the drawings, and more particularly to FIGS. 1-10, an exemplary embodiment of the present invention will now be described.

It is noted that one of ordinary skill in the art, after having read the details described herein, would readily be able to apply and implement the present invention in any number of variable embodiments and situations.

The present invention includes a process that is used to implement a system for a computerized business interaction between business entities for performing tasks such as placing and servicing orders, and to a use of computer tools to configure and support such processes. The business interaction incorporates business process and data transformation elements, and runs from one business partner's fulfillment system, through its B2B gateway, to the other partner's gateway and on to its fulfillment system. Once the business interaction has been created for the first time, it is desirable to leverage the investment in it by creating a standardized, modular, and highly repeatable process (a “boarding process”) that allows the business interaction to be repeated rapidly and cost effectively with further partners.

Generally speaking, boarding processes may suffer from a number of weaknesses. First, they may under- or overestimate the impact of any of the many constraints upon the process. Second, they may not define the scope of the business interaction sufficiently tightly. Third, they may incorporate an inefficient arrangement of the work required.

Fourth, they may be insufficiently supported by tools and “pro-form a” templates and checklists, which then are recreated each time the process is used. Fifth, they may not trap errors sufficiently early in the process, so that when they are found (for example during testing) they become more expensive and time consuming to correct. Sixth, they may not provide for sufficient involvement of the trading partner, leaving scope for misunderstandings and miscommunications.

In the above cases, the result is a boarding process that takes longer, costs more, and satisfies each party less, than might otherwise be the case.

However, standardizing the boarding process is difficult, because requirements will vary greatly each time it is used, depending on factors that range from the inherent complexity of the business interaction itself, through to whether each partner's staff speak the same language.

Fortunately, these factors can be identified in advance and their impact on the process predicted from previous experience. Therefore, a key aspect of the present invention is the recognition that knowledge can be deployed via a computerized process management tool that allows the boarding process to be configured automatically in response to a series of questions answered by the user, according to the specific formats and protocols of the business interaction and logistical requirements of a new trading partner, while referencing a single core set of activities, tasks, and related documentation.

Thus, using the computer tool of the present invention, a single boarding process is rendered significantly more versatile than would otherwise be possible.

In the context of managing a technical project, the role of e-rooms or collaboration centers to serve as electronic libraries for sharing documents, such as templates, among team members engaged in a common project is well established.

Another aspect of the present invention is also well understood, namely the use of “expert” systems capable of asking the user questions (in this case about the nature of the partner boarding process to be undertaken) and making “decisions” about the most efficient and realistic configuration of the boarding process, consequent upon the answers that the user supplies.

The present invention provides a framework within which to configure the best boarding process for the specific circumstances faced, that can also be used as the basis for an “expert system” tool. This tool could present the user with a set of questions to cover the different parameters that affect time taken and complexity in the boarding process and, in response to the answers provided, present a) the optimum boarding process (e.g., activities, tasks, and durations) and b) the necessary support documentation (e.g., checklists, templates, reference materials).

The present invention also provides a boarding process that, for any of the circumstances that might be faced, is the optimum (i.e., the most efficient and effective) boarding process. This is achieved from the “knowledge base” that the configuration tool draws upon. The knowledge base contributes in several ways, as follows.
It contains the “superset” of all the activities that IBM's accumulated experience has shown would ever be required in any type of boarding.
It embodies what IBM's extensive experience has shown to be “best practices” for boarding processes.
It contains the decision logic, again based on IBM's extensive experience, that allows the configuration of the boarding process for different circumstances.
It contains details of the likely risks with each type of boarding process and the management actions necessary to accommodate these risks.
It contains all of the support documentation, checklists and templates necessary to create the deliverables in the process.

The knowledge base continues to grow over time as further experience is accumulated that one chooses to add to it, so ensuring that the concepts of best practice in the tool continue to evolve and themselves improve.

FIG. 1 shows a B2B environment in which the present invention might be implemented. Company A 101 wishes to enter into a business agreement with a second company B 102, and each company desires to establish, possibly via a world wide network (e.g., the Internet) 103, an electronic link through which to conduct routine business such as placing purchase orders.

Although shown only for company B, typically, each company 101, 102 will have at least three B2B functional components, each having B2B software, and including a gateway 104, a B2B server 105, and a data translation and distribution server 106, all of which provide an interface to the company's back end applications 107, such as Enterprise Resource Planning (ERP) to the Internet 103.

Gateway 104 provides the interface to the Internet 103, typically providing channel management to multiple trading partners in addition to company A via a firewall. B2B server 105 provides the functions of scheduling and choreography, resend/retry, non-repudiation, error and exception handling, and HTTPS (Hypertext Transfer Protocol that uses SSL (Secure Socket Layer) encryption) and security management.

Data translation and distribution server 106 provides the functions of XML message assembly from/distribution to the back end systems 107, generation of RosettaNet (RN) messages from back end data, translation of RN data to back end applications 107. The data translation and distribution function is typically provided via the company's Enterprise Application Integration (EAI) software “bus”. RosettaNet refers to a set of standards defining the business process and data content of B2B transactions, as defined by the RosettaNet consortium.

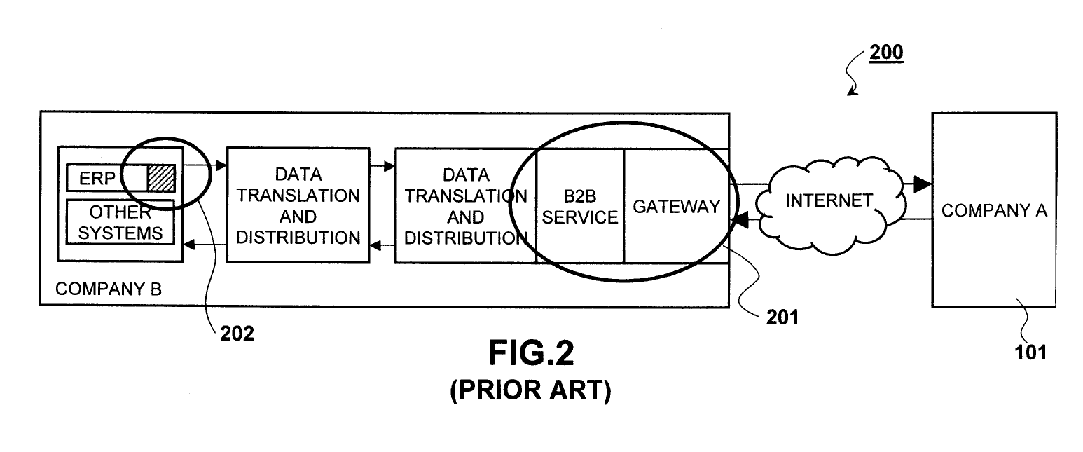

FIG. 2 shows a typical variation 200 that, in practice, these three elements typically get intermixed. For example, many companies (and products) combine elements of their gateway with their B2B service and even their data translation into an expanded gateway 201. Additionally, the ERP systems increasingly provide their own data translation and distribution services via built-in EAI capabilities 202.

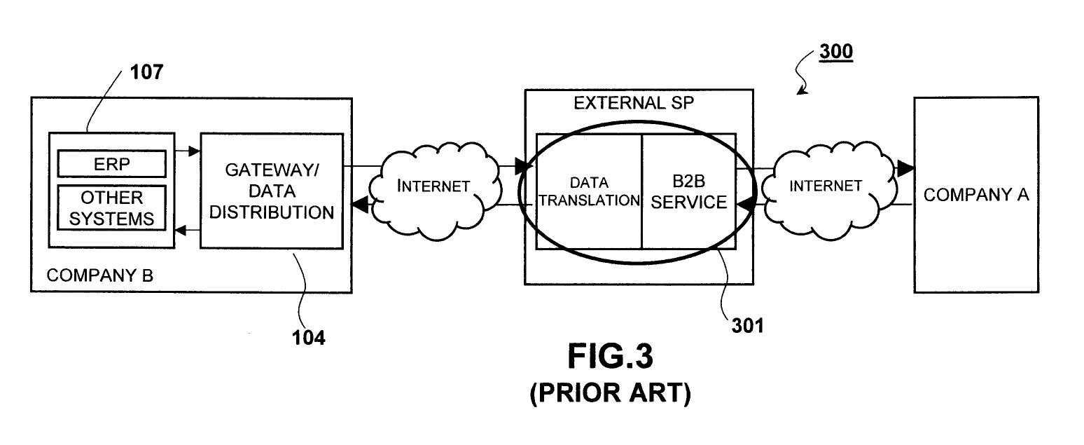

FIG. 3 shows another typical variation 300 in which one or more B2B components are outsourced and located outside the firewall. A typical example might be the scenario in which an external service provider 301 provide B2B service, and possibly data translation, to one or both of Company A and Company B. In this scenario, Company B would still need to distribute data to/aggregate it from its back end systems 107, using gateway 104 and data distribution 106.

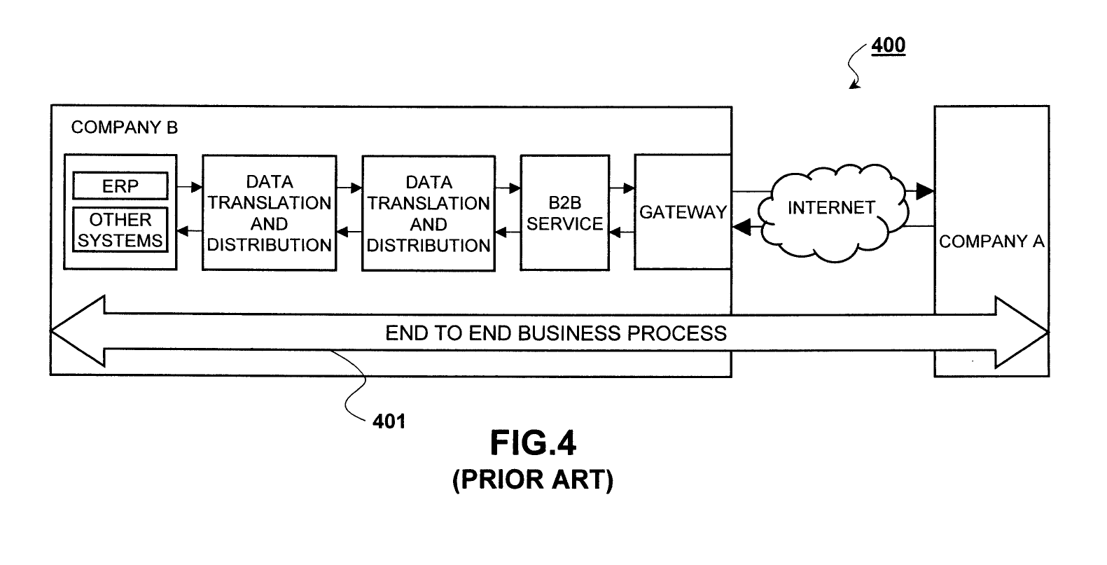

FIG. 4 shows a fourth B2B concept 400, the end-to-end business process 401, that many studies show to be the key catalyst for maximum benefit to both companies. An end-to-end business process 401 is one which structures activity and data seamlessly within and between businesses, from one company's back end right through to the other company's back end. This process offers visibility of activity all along its length and structures the architecting of the many systems that might be required to deliver it.

As competition becomes increasingly intense in the increasingly electronically-interconnected business environment, businesses find that it becomes necessary to increase the pace of B2B implementations with customers and distributors, in order to retain loyalty and to achieve the significant returns available within the business.

As mentioned above, B2B implementations can involve substantial variations in cost and time. Thus, in the scenario of FIG. 1, in which Company A implements a B2B partner on-boarding of Company B, the business methods and protocols at the back end of Company B must be integrated with those of Company A. This boarding process can take months and in extreme cases cost hundreds of thousands of dollars to implement.

The methodology of the present invention provides a structure and organization to reduce this implementation effort as taking only weeks and costing only thousands or tens of thousands of dollars.

For a specific large company, such as the assignee of the present invention, the process provides a standardized method to enable B2B communications with the on-boarding process of multiple trading partners. That is, this method creates a standard, single, rapid, efficient, and reliable on-boarding process to be used company-wide (and, potentially, industry-wide) that:
Encourages standardization and re-use by assembling and deploying a single set of approaches, documents, tools, and other collateral;
Can be adapted in a modular fashion to the requirements of specific business processes and/or partners;
Reduces the number of late implementation or production problems related to specific customer boardings;
Enables/is enabled by a small implementation team, based on concurrent engineering practices and incorporating customer input; and
Enables budgeting and cost prediction for B2B activity by creating a predictable, highly repeatable process.

The concept of implementing B2B boarding disclosed by the present invention includes the following design principles:
Creating a highly repeatable process with a “drumbeat” or rhythm from key events that are intended to drive progress. Key events include, an orientation/planning meeting, a gap analysis, one or more transaction confirmation or design workshop(s), testing, implementation, and proof of benefit achieved;
Creating profiles of the core process for specific usage scenarios;
Elimination of downstream and production errors with upstream planning and use of a test simulator, thereby becoming faster overall;
Elimination of separate quality deliverable, in favor of success criteria for individual activities and performance measures to allow performance to be monitored and continually improved.

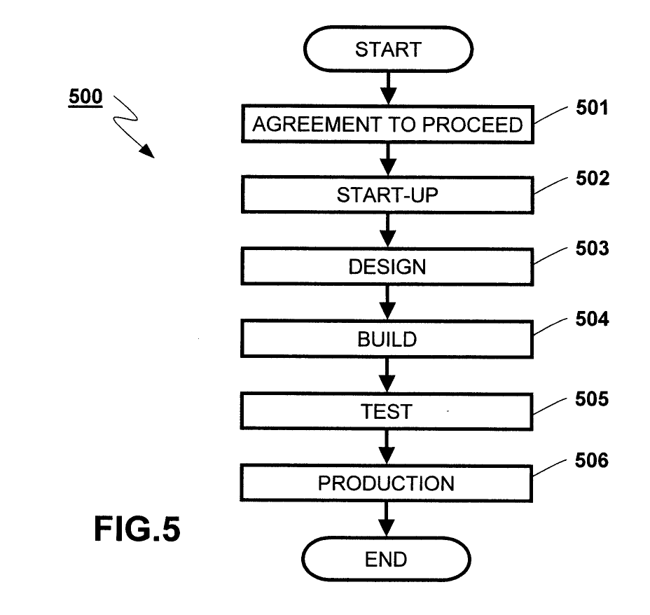

FIG. 5 shows an overview flowchart 500 of the B2B on-boarding implementation in accordance with the present invention.

Initially, in step 501, the two trading partners have negotiated an agreement on such business-related goals as products to be covered, business interaction(s) required, geographical regions involved, and funding and resources.

The next five steps summarize the five main phases of the on-boarding implementation of the present invention.

In the start-up phase shown in step 502, the respective teams mobilize, initial education is provided if one of the companies is not familiar with the on-boarding process, and basic information is exchanged. A key component of this phase is a gap analysis in which the differences between the back ends of each company are identified.

In the design phase of step 503, if necessary, one or more sample transactions are evaluated, an approach to detected deviations is agreed upon, a boarding plan is confirmed, and preparations for implementation are completed.

In the build phase of step 504, any necessary internal changes are made and the physical implementation is completed.

In the test phase of step 505, the testing needs are identified, the tests are set up, and the tests are carried out to test connectivity, functionality of the implementation, production, and, if necessary, the end-to-end capability.

Finally, in the production phase of step 506, the fully-implemented on-boarding system is handed over to the production group, which will be the primary users of the system.

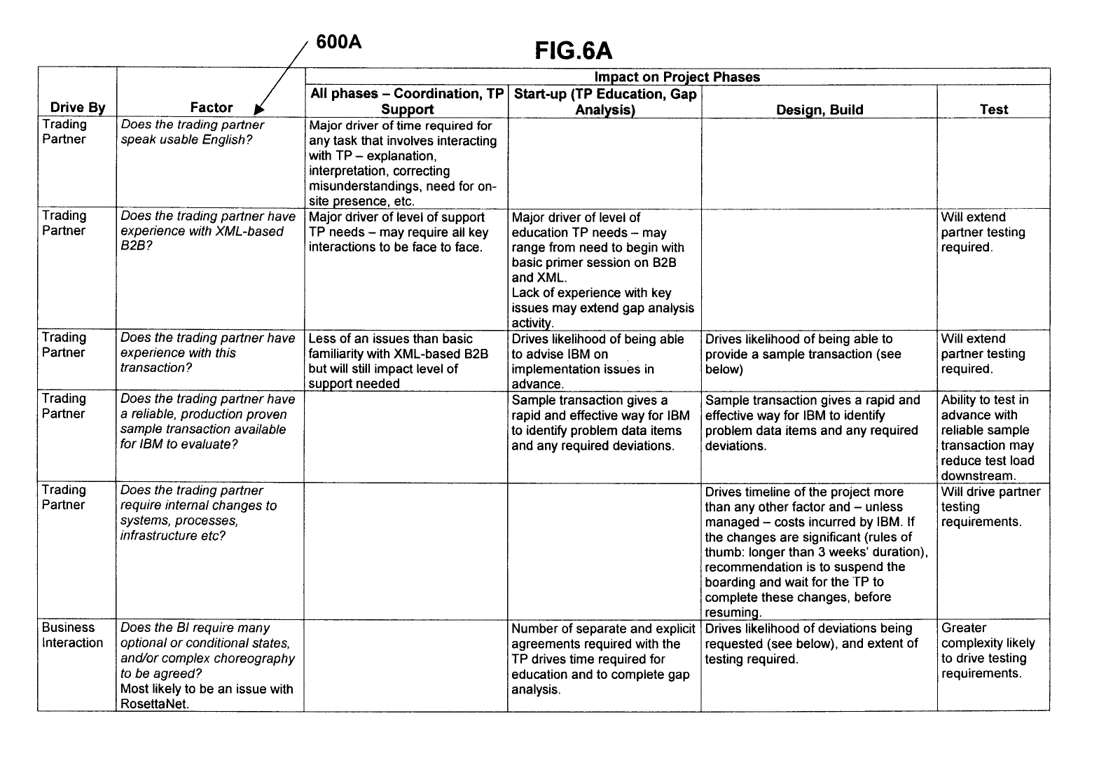

FIGS. 6A, 6B, and 6C show in chart format exemplary questions 600A, 600B, 600C to demonstrate an exemplary type of questions that might be used in the computer tool of the present invention to isolate the potential problems of a boarding process with a new trading partner.

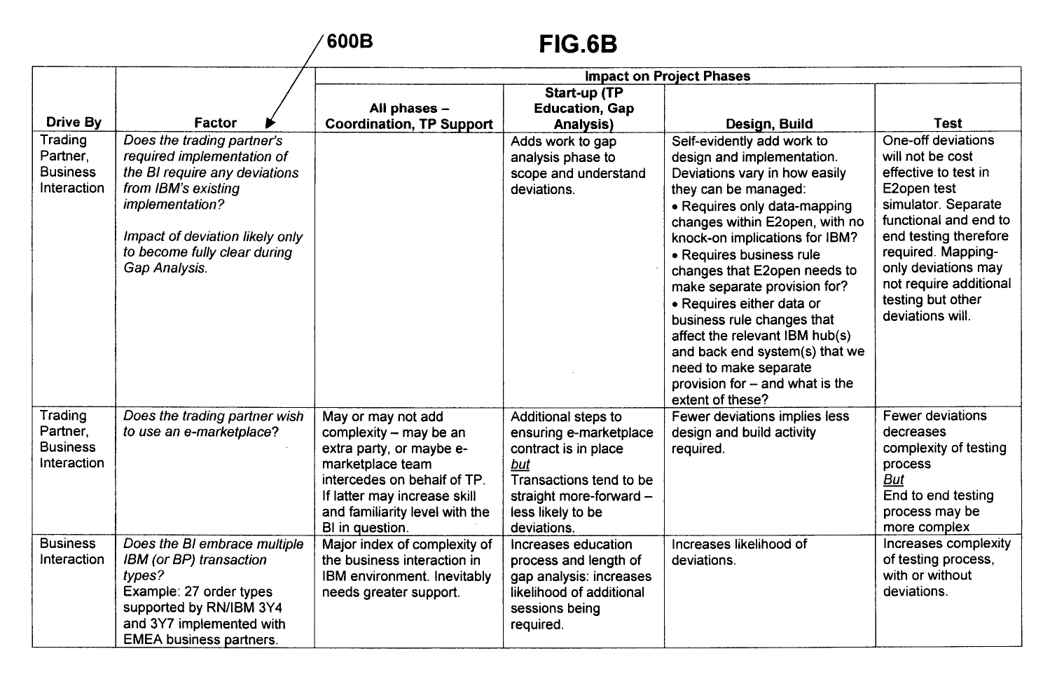

FIG. 7 shows an exemplary flowchart 700 of the computerized steps of a B2B boarding process.

In step 701, a set of prepared questions, such as shown in FIGS. 6A-6C, is presented to the potential new trading partner. In step 702, the user responds to the questions presented, exemplarily by making manual inputs to the questions presented on a screen. In step 703, the potential trading partner's responses are checked against a knowledge base containing typical time, resource and risk impacts possible for each question.

In step 704, based on the responses and the information in the knowledge base, the present invention will display or print the indicative timelines, resource requirements, risks and mitigation actions, and support documents and checklists.

Returning to FIG. 5, this information from step 704 is then used in the design and build steps 503, 504. One of ordinary skill in the art would readily recognize that “expert” systems could also automatically implement one or more software module components for the trading partner's side of the B2B process.

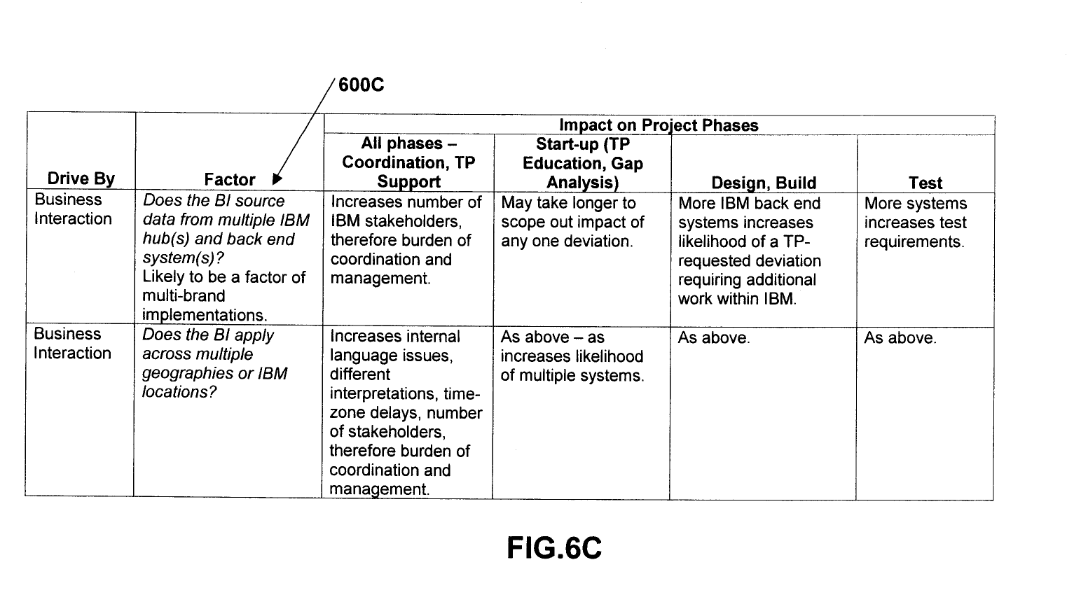

FIG. 8 exemplarily shows the software modules of the computerized tool of the present invention. User interface 801 allows interface with users to control the tool, for boarding process questions to be initially entered for the boarding process questionnaire, for a representative of the potential trading partner to enter responses to the boarding process questionnaire, and for the results of the database search to be displayed or printed.

Memory interface 802 allows the questionnaire to be compared with the database 803. Control module 804 is a software module that coordinates the activities of the users and the connection between the memory interface 802 and the database 803.

As previously mentioned, “expert” system modules 805 can be used to assist in using the data already in the database 803 to develop boarding processes for the questionnaire responses of a potential trading partner. In various embodiments of the present invention, the “expert” system modules 805 could be incorporated as a module of the computer tool 800, could be stand-alone modules to be invoked as necessary by a control module 804 providing interface with the database 803, or could be associated with the database 803. Control module 804 might also be used for updating the database 803, either automatically or through user inputs.

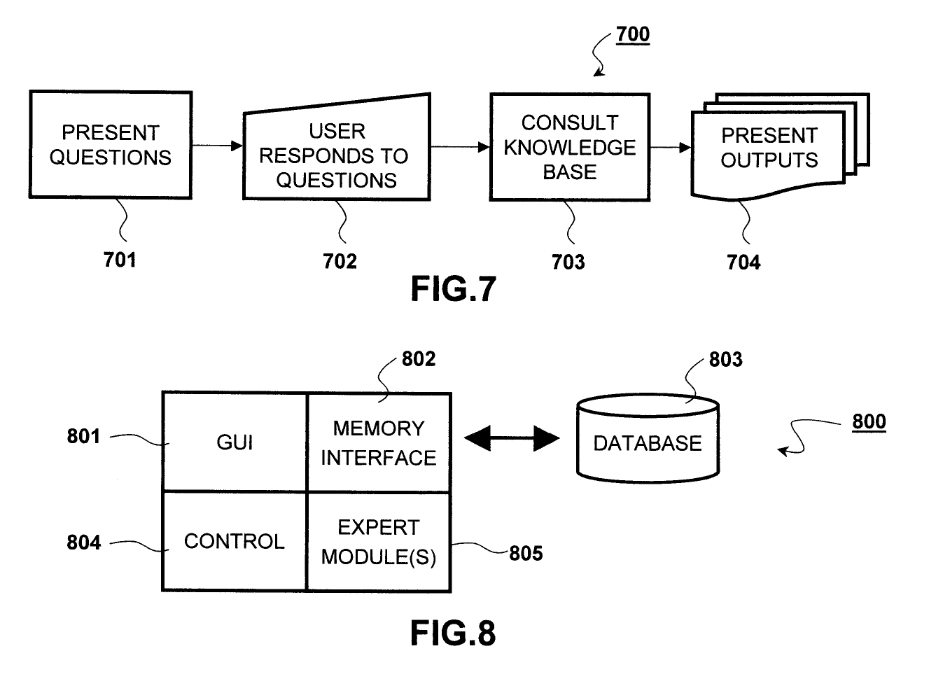

FIG. 9 illustrates a typical hardware configuration of an information handling/computer system in accordance with the invention and which preferably has at least one processor or central processing unit (CPU) 911.

The CPUs 911 are interconnected via a system bus 912 to a random access memory (RAM) 914, read-only memory (ROM) 916, input/output (I/O) adapter 918 (for connecting peripheral devices such as disk units 921 and tape drives 940 to the bus 912), user interface adapter 922 (for connecting a keyboard 924, mouse 926, speaker 928, microphone 932, and/or other user interface device to the bus 912), a communication adapter 934 for connecting an information handling system to a data processing network, the Internet, an Intranet, a personal area network (PAN), etc., and a display adapter 936 for connecting the bus 912 to a display device 938 and/or printer 939 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 911 and hardware above, to perform the method of the invention.

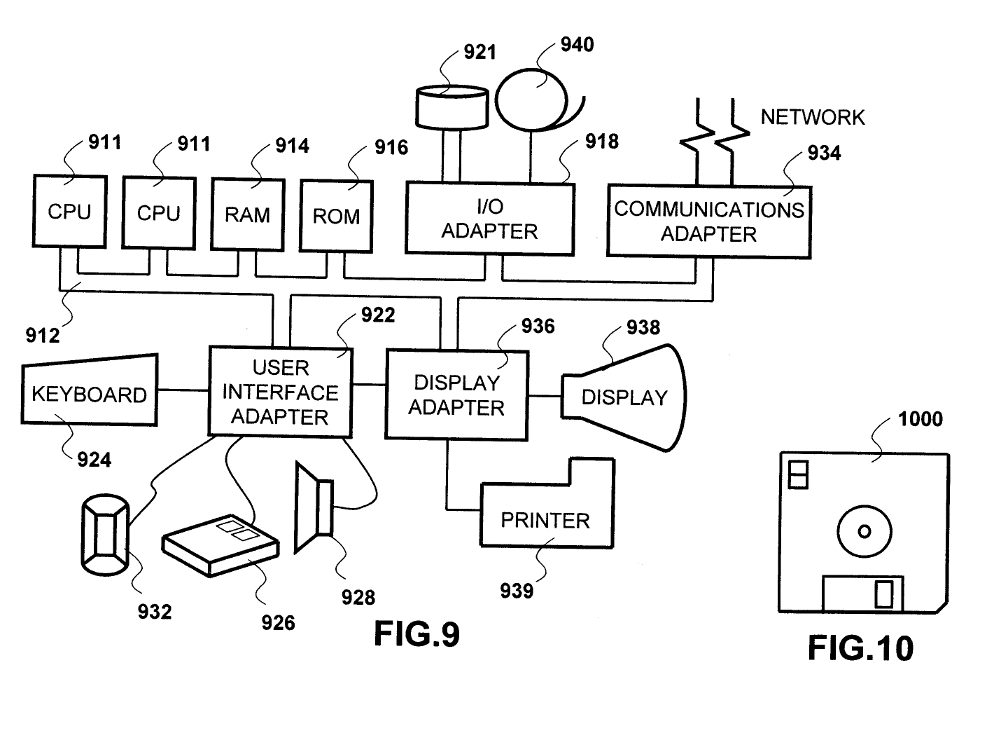

This signal-bearing media may include, for example, a RAM contained within the CPU 911, as represented by the fast-access storage for example. Alternatively, the instructions may be contained in another signal-bearing media, such as a magnetic data storage diskette 1000 (FIG. 10), directly or indirectly accessible by the CPU 911.

Whether contained in the diskette 1000, the computer/CPU 911, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

Yet another aspect of the present invention is the potential for using it as a component of a service. In this aspect, although a business entity might utilize the concepts described above to implement a boarding process with new trading partners, a business can also revolve around providing a service to others (e.g., over a network or the like), based on implementing boarding processes.

As non-limiting examples of how such service might be achieved, a company might specialize in providing a service to others to set up boarding processes in the expedited manner of the present invention. In this scenario, a company provides a consultation service to other companies to implement boarding processes for new trading partners, using, in part, the computer tool described above.

It should be apparent to one of ordinary skill in the art, after taking the present disclosure as a whole, that such service could be implemented via the Internet, wherein a questionnaire is downloaded to a client's potential new trading partner. The responses would then be analyzed with a boarding process database and the results provided to either or both the client and the potential new trading partner.

Another potential service based on utilizing the present invention is the maintenance and provision of a database containing B2B boarding process data, thereby making available the service of providing the data for comparison with the potential trading partner's questionnaire responses.

Yet another potential service would be the development of software modules utilizing “expert” system technology for analyzing the potential trading partner's questionnaire responses, for generating information related to the boarding process with the potential new trading partner, and/or for generating components of the new boarding process to be implemented.

The present invention provides an optimum process that is configured automatically or semi-automatically for any type of boarding. It provides a savings in time taken and cost to achieve any given boarding, both from improved process and fewer errors. It provides an increase in scalability of B2B, including an ability to be rolled out to multiple trading partners. Thereby, the present invention enhances the “network effects” for the companies operating the B2B transaction without question, and so offers further economies of scale.

While the invention has been described in terms of exemplary embodiments, those skilled in the art will recognize that the invention can be practiced with modification within the spirit and scope of the appended claims.

Further, it is noted that Applicants' intent is to encompass equivalents of all claim elements, even if amended later during prosecution.

Having thus described our invention, what we claim as new and desire to secure by Letters Patent is as follows:

1. A computerized method of implementing a business-to-business (B2B) boarding process, said method comprising:
providing a set of questions related to said B2B boarding process to a new business to be boarded into an existing B2B system, responses of said set of questions being tangibly embodied in a machine-readable storage medium.

2. The method of claim 1, further comprising:
comparing a set of responses, using a processor, to said set of questions to data in a B2B database to determine which of existing processes or components in said existing B2B system are appropriate for said boarding process.

3. The method of claim 1, further comprising:
comparing a set of responses, using said processor, to said set of questions to data in a B2B database to determine what changes are necessary to existing processes or components in said existing B2B system for said boarding process.

4. The method of claim 1, further comprising:
comparing a set of responses, using said processor, to said set of questions to data in a B2B database to determine what computerized processes or components are necessary for said new business to implement to set up a new B2B system with said existing B2B system.

5. The method of claim 2, further comprising, as executed by said processor, at least one of:
providing information related to implementing a B2B system with said new business;
automatically developing one or more components of a B2B system in said existing B2B system for said new business, based on said comparing; and
automatically implementing one or more components of a B2B system in said existing B2B system for said new business, based on said comparing.

6. The method of claim 1, wherein said B2B boarding process conforms to a RosettaNet set of standards.

7. The method of claim 5, wherein said information related to implementing a B2B system comprises at least one of:
a listing of tasks to be performed;
a milestone report; and
a time schedule.

8. An apparatus, comprising a graphical user interface (GUI) as executed by a processor, for at least one of:
providing a set of questions related to a business-to-business (B2B) boarding process to a new business to be boarded into an existing B2B system;
means for allowing a user to respond to said set of questions;
means for entering said set of questions into a questionnaire;
means for entering commands to control an analysis of said responses with a database containing B2B boarding process information; and
means for displaying a result of said analysis.

9. The apparatus of claim 8, further comprising:
a memory interface to said database, as executed by said processor.

10. The apparatus of claim 9, further comprising at least one expert system, as executed by said processor, to at least one of:
compare said responses with said B2B boarding process information in said database;
prepare information for a new boarding process based on said responses; and
prepare components for said new boarding process.

11. A server in a computer network, said server comprising:
a memory containing data on a business-to-business (B2B) boarding process for comparison with responses to a questionnaire for a new B2B boarding process.

12. The server of claim 11, further comprising at least one expert system, as executed by a processor, to at least one of:
compare said responses with said B2B boarding process information in said database;
prepare information for a new boarding process based on said responses; and
prepare components for said new boarding process.

13. A system comprising:
a database containing business-to-business (B2B) boarding process information;
a user interface (UI), as executed by a processor, for at least one of:
providing a set of questions related to said B2B boarding process to a new business to be boarded into an existing B2B system;
means for allowing a user to respond to said set of questions;
means for entering said set of questions into a questionnaire;
means for entering commands to control an analysis of said responses with said database containing B2B boarding process information; and
means for displaying a result of said analysis; and
a memory interface to said database, as executed by said processor.

14. The system of claim 13, further comprising at least one expert system, as executed by said processor to at least one of:
compare said responses with said B2B boarding process information in said database;
prepare information for a new boarding process based on said responses; and
prepare components for said new boarding process.

15. A signal-bearing storage medium tangibly embodying a program of machine-readable instructions executable by a digital processing apparatus to perform a computerized method of assisting an implementation of a business-to-business (B2B) boarding process, said instructions on said signal-bearing storage medium comprising at least one of:
instructions to present a set of questions related to said B2B boarding process to a new business to be boarded into an existing B2B system;
instructions for a user interface (UI) for at least one of:
providing a set of questions related to said B2B boarding process to a new business to be boarded into an existing B2B system;
means for allowing a user to respond to said set of questions;
means for entering said set of questions into a questionnaire;
means for entering commands to control an analysis of said responses with said database containing B2B boarding process information; and
means for displaying a result of said analysis;
instructions to interface to said database; and
at least one expert system to at least one of:
compare said responses with said B2B boarding process information in said database;
prepare information for a new boarding process based on said responses; and
prepare components for said new boarding process.
